(19) United States
(12) Patent Application Publication
(10) Pub. No.: US 2026/0209038 A1
(43) Pub. Date: Jul. 23, 2026

(54) AMMONIA CRACKING FOR HYDROGEN PRODUCTION

(71) Applicant: CASALE SA, Lugano (CH)

(72) Inventors: Sergio PANZA, Como (IT); Dario DI ADDEZIO, Lugano (CH)

(21) Appl. No.: 19/140,133

(22) PCT Filed: Jan. 12, 2024
(86) PCT No.: PCT/EP2024/050723

§ 371 Date: Jun. 17, 2025

(30) Foreign Application Priority Data
Jan. 13, 2023 (EP) 23151616.2

(51) Int. Cl. C01B 3/047; B01D 53/047; C01B 3/56

(52) U.S. Cl. CPC C01B 3/047; B01D 53/047; C01B 3/56; B01D 2256/16; B01D 2257/102; C01B 2203/0277; C01B 2203/042; C01B 2203/0822; C01B 2203/0883; C01B 2203/0894; C01B 2203/1205

(57) ABSTRACT

Process for production of hydrogen from ammonia, including ammonia cracking wherein ammonia is decomposed into hydrogen and nitrogen, wherein the ammonia cracking is performed in a sequence of cracking steps (13, 36, 17, 20) and a finally cracked stream (21) is obtained after a last cracking step (20), wherein the last ammonia cracking step (20) is performed adiabatically and/or the finally cracked stream (21) is quenched by direct mixing with water or steam after the last cracking step.

### FIELD OF APPLICATION

The invention is in the field of hydrogen production based on ammonia cracking.

### PRIOR ART

Ammonia cracking is of considerable interest, particularly for the production of hydrogen. In the ammonia cracking process, ammonia is decomposed into H₂ and N₂ in the presence of heat and a suitable catalyst. Typical catalysts for ammonia cracking include Ni-based, Ru-based, Pt-based and Iron based catalysts.

Conventionally, the ammonia cracking process is performed by passing the ammonia feed through catalytic tubes of a fired furnace, optionally after a pre-cracking step. A challenge of this process is the high temperature of the cracked stream effluent from the catalytic tubes, which is typically around 750° C. The related drawbacks include: life of the catalyst and of the tubes is affected by such high working temperature; the downstream equipment traversed by the process stream, particularly the heat exchangers, are exposed to nitriding and hydrogen attack, so that they require expensive material such as high-nickel alloyed steel. This problem is suffered particularly by gas/gas heat exchangers which are required to operate at high temperature, high pressure and in the presence of hydrogen and nitrogen, which are very severe condition for metal surfaces.

Ammonia cracking for production of hydrogen is disclosed in WO 2022/243410 and WO 2022/265650.

### SUMMARY OF THE INVENTION

The invention faces the challenges posed by the high temperature of the cracked stream effluent from catalytic tubes, which still affects the prior art of ammonia cracking processes.

The aims of the invention are reached with a process according to the claims. In the process of the invention, the cracking of ammonia is performed in a sequence of steps until a finally cracked stream is obtained. The term finally cracked stream denotes the stream obtained after a last cracking step, which contains predominantly hydrogen and nitrogen, and may contain small amounts of unreacted ammonia.

The temperature of the finally cracked stream is reduced, compared to the prior art, by performing the last cracking step adiabatically or by quenching the finally cracked stream.

The invention comes from the ingenious finding that the temperature of the cracked stream can be significantly reduced if the last cracking step is adiabatic or by quenching the cracked stream. The quench could be accomplished with water, steam, ammonia or a gaseous cold stream or a mixture of the previously mentioned compounds. When the last cracking step is adiabatic, the temperature of the process stream is reduced by the absorption of heat caused by the endothermic cracking itself. In this case the invention comes from the finding that the cracking itself can be regarded as a suitable heat dwell to reduce the temperature of the process stream, instead of conventional cooling. This is in contrast with consolidated prior art wherein adiabatic cracking, if any, was used only for initial pre-cracking steps.

A noticeable feature of some embodiments of the invention is the arrangement of adiabatic reactors in a sequence. This denotes that adiabatic reactors are series-connected, so that the effluent of a first reactor is further reacted in the next reactor and so on until the last reactor.

A very interesting advantage of performing a last cracking step adiabatically is that a finally cracked stream at a lower temperature is obtained without the need to exchange heat with a cooling medium, which would require a heat exchanger adapted to work at very high temperature. Similarly, quenching of the stream is performed by direct mixing with a cooling medium, which is generally water or steam, thus it does not require a large heat exchange surface made of expensive material.

According to embodiments of the invention, the cracking steps may include one or more steps performed adiabatically and may include a step performed in catalytic tubes of a furnace. Said tubes are heated externally by the heat generated in the combustion process of the furnace, i.e. by radiant heat and/or contact with hot fumes. A gas-heated reactor or an adiabatic reactor may also operate in parallel to the catalytic tubes. For example, a gas-heated reactor may be heated with effluent of the same catalytic tubes, so that the hot effluent of the tubes is cooled by transferring heat to a parallel cracking process.

The provision of the above-mentioned catalytic tubes is an option. In an embodiment, the entire cracking process is performed in a sequence of adiabatic cracking steps without a passage through catalytic tubes.

The adiabatic cracking steps may be performed in separate adiabatic reactors with separate pressure vessels, or in catalytic beds contained in a single pressure vessel. Intermediate heating steps are provided between adiabatic cracking steps, to provide the necessary reaction heat. In an embodiment, intermediate heating is provided by heat exchangers or coils arranged in a fired furnace and heated by the combustion process of the furnace. In certain embodiments, part of the reaction heat or all the reaction heat may be provided by electric heaters.

### DESCRIPTION OF THE INVENTION

An aspect of the invention is a process for production of hydrogen from ammonia, including ammonia cracking wherein a gaseous ammonia feed is catalytically decomposed into hydrogen and nitrogen, wherein the ammonia cracking is performed in a sequence of ammonia cracking steps wherein a finally cracked stream is a stream obtained after a last ammonia cracking step, wherein said last ammonia cracking step is performed adiabatically without providing heat to the process stream under cracking, and/or said finally cracked stream is quenched by direct mixing with water and/or steam before said indirect heat exchange.

Said finally cracked stream may be a stream before removing heat by indirect heat exchange with one or more cooling fluids.

The finally cracked stream after the last step of cracking, or after quenching if provided, has a temperature much lower than effluent of catalytic tubes of the prior art. Preferably said stream has a temperature not greater than 700° C. or not greater than 650° C. or not greater than 550° C. or not greater than 500° C. More preferably said stream has a temperature in the range 350 to 700° C. or 350 to 650° C. or 250 to 550° C.

The temperature of the feed of each cracking step is preferably 300° C. to 650° C. During an adiabatic cracking step, the temperature of the process stream may decrease by 50° C. to 400° C., preferably 200° C. to 300° C. or 250° C. to 300° C. In a preferred embodiment of the invention, the cracking process is performed under pressure. Preferably the cracking process is performed at a pressure in the range of 5 bar to 55 bar. An advantage of performing the ammonia cracking under pressure is that energy for compression of the so obtained hydrogen may be saved, or no compression may be required. The pressure is given in bar gauge. Still another advantage of operating under pressure is reduction of size of the equipment like reactors, PSA units, membrane separation units and others.

The adiabatic reactors may have axial flow, radial flow or a mixed axial-radial flow. In embodiments wit radial or mixed flow, the radial flow may be inward or outward.

In a preferred embodiment, said sequence of ammonia cracking steps is arranged so that the effluent of each cracking step is entirely sent to the next cracking step of the sequence. The effluent of each cracking step, preferably, is sent to the next step as such or after a heat exchange, preferably without a further processing that modify the composition of the stream, such as separation of components.

Preferred embodiments of the invention are recited in the attached claims. The following includes a description of various features and embodiments of the invention, followed by a description of preferred general embodiment.

### Fresh Ammonia Feed

The fresh ammonia feed is typically liquid ammonia. Said liquid ammonia may be heated and evaporated with heat removed from the ammonia cracking process, for example by removing heat from the finally cracked stream or from purified hydrogen or from distillation of an aqueous ammonia solution (aqua-ammonia solution). Said aqueous solution may be withdrawn from a gas scrubbing process to remove unreacted ammonia from the cracked stream. Electrical heating can also be adopted to heat and vaporize the liquid ammonia.

The gaseous ammonia, obtained after evaporation, may be superheated in a furnace until it reaches a suitable temperature for the cracking process, for example above 400° C., or above 500° C. and more preferably above 600° C., such as 650° C.

### Hydrogen Purification

The finally cracked stream, which contains predominantly ammonia and hydrogen, is processed to obtain hydrogen of a desired purity. The target purity of hydrogen may be 99% or greater, in some embodiments it may be as high as 99.999%.

The hydrogen-containing cracked stream, after the last cracking step, is typically cooled by transferring heat to the fresh ammonia feed to be evaporated. Thereafter, the cracked stream can be further cooled, preferably to a temperature of 5 to 60° C. and the so obtained cooled gaseous mixture can be optionally scrubbed with water to remove unreacted ammonia.

The so obtained scrubbed gas may be sent to a suitable hydrogen separation system, such as a PSA (pressure swing absorption) unit or a membrane-based system, to produce hydrogen of the target purity and a tail gas. Said tail gas may be recycled as a fuel, for example as a fuel of a fired furnace. In some embodiment a tail gas withdrawn from a first PSA unit is compressed and sent to a second PSA unit to enhance hydrogen recovery. The flue gas produced inside the fired furnace may be used also for pre-heating of combustion air.

As above, the gas scrubbing produces an aqua-ammonia solution. This solution can be sent to a distillation column equipped with a reboiler and condenser. The reboiler may be heated electrically or with steam, for example steam produced by removing heat from the cracked ammonia.

A portion of ammonia vapours emerging from top of said distillation column may be mixed with liquid ammonia or with gaseous ammonia, provided they are at a sufficient pressure. A remaining portion may be condensed and sent back to the column. Alternatively, the entire stream of ammonia vapours is condensed and a portion is recycled as ammonia feed.

The various embodiments of the invention may include a makeup of hydrogen which is taken from a hydrogen storage or buffering system. Said storage or buffering system can be added to the fuel gas system in order to stabilize the ammonia cracking process and to have an independent source of fuel gas available at battery limits both during normal operation and during start-up.

A fuel gas different than hydrogen, such as ammonia, synthesis gas, natural gas, or in general a hydrocarbon source, can be conveniently adopted to maximize the ammonia conversion to hydrogen.

### Hybrid Options

In some embodiments, the cracking process of the invention is hybridized by providing a portion of heat input electrically. The electrically-provided heat input may include one or more of the following: heat for reboiling the aqua-ammonia solution; heat for pre-heating or evaporating the liquid ammonia feed; heat for pre-heating combustion air of a fuel-fired furnace; heat for cracking ammonia.

In some embodiments an electric heating of the process stream is provided before or after a furnace. Electric heaters may be installed inside or outside a furnace.

In other embodiments the ammonia cracking reactor can be arranged with a tube heated or plate-heated design to sustain the cracking reaction. In certain embodiments, to achieve greater ammonia conversion toward the product, the heating stream can be the gaseous ammonia itself or a stream of H₂ and N₂ or water steam or a combination of the previous; alternatively or additionally, in some embodiments, heat can be provided by means of electrodes.

In other embodiments a gas turbine is installed to combine power generation with hydrogen production. According to embodiments of the process of the present invention, a portion of the fuel of the process is sent to a gas turbine and exhaust gas of said turbine are used as a heat source in the ammonia cracking process. For example, the exhaust gas of the gas turbine may be used to heat a bundle of catalytic tubes in a furnace. In a preferred embodiment, the installation of a gas turbine is combined with ammonia cracking performed with catalytic tubes, followed or preceded by adiabatic ammonia cracking reactors; the gas turbine can be included also in a plant layout made by adiabatic cracking reactors only.

In some embodiments, a gas turbine is integrated in the steam generation system and coupled with a heat recovery steam generator (HRSG) to generate electricity through a steam turbine, wherein the hot exhaust gas of the gas turbine is used in the HRSG to produce steam for the steam turbine.

The process may include a fuel gas system to provide fuel to any fired equipment, such as fired furnace. In some embodiments a makeup hydrogen can be added to said fuel gas system. In some embodiments natural gas or an external fuel source may be used to supplement the fuel gas. The above-mentioned gas turbine may be installed as part of the fuel gas system.

### First Embodiment

In a first embodiment, the cracking of ammonia is performed entirely in a sequence of adiabatic reactors. This means that the process does not include cracking in heated catalytic tubes. A fired furnace may be used in this embodiment to provide intermediate heating steps, to heat the partially cracked effluent of one or more adiabatic reactors before it is fed to a next reactor of the sequence. A preferred number of adiabatic reactors in the sequence is three or four. Each reactor contains at least one catalytic bed. In some embodiments a a single reactor may contain more than one catalytic bed.

The catalytic reactors are preferably separate reactors, each reactor having a respective pressure vessel. The reactors are connected in series, so that the effluent of each but the last reactor is further cracked in the next reactor of the sequence. The finally cracked stream is obtained at the output of the last reactor of the sequence. Generally, said finally cracked stream has a temperature low enough to avoid use of expensive materials in the following equipment; optionally it can be quenched, preferably with water and/or steam, if necessary.

A particularly preferred implementation of said first embodiment of the invention is:
a process for production of hydrogen from ammonia, including ammonia cracking wherein a gaseous ammonia feed is catalytically decomposed into hydrogen and nitrogen, wherein the ammonia cracking is performed in a sequence of preferably three or four ammonia cracking steps wherein a finally cracked stream is a stream obtained after the last cracking step, wherein all said ammonia cracking steps are performed adiabatically without providing heat to the process stream under cracking, each cracking step is performed separately in an adiabatic reactor, each partially cracked stream directed to a next reactor in the sequence is heated by passing through a heat exchanger or coil in a fuel-fired furnace, before entering the next reactor.

### Second Embodiment

In a second embodiment, the cracking process is performed partly in one or more adiabatic reactors and partly in externally heated catalytic tubes. One or more adiabatic reactors may be provided upstream or downstream or both upstream and downstream the catalytic tubes, which means the cracking step in the tubes can be performed before or after adiabatic cracking.

In this second embodiment the cracking is performed partly adiabatically and partly non-adiabatically with provision of heat. Variant of said second embodiment may include:
a first cracking step through one or more adiabatic reactors in a sequence, followed by a final cracking step in the catalytic tubes and quench of the finally cracked stream (adiabatic/tubes/quench);
a first cracking step through one or more adiabatic reactors in a sequence, followed by a cracking step in the catalytic tubes, followed by a final cracking step in one or more adiabatic reactors in sequence (adiabatic/tubes/adiabatic);
a first step of cracking in the catalytic tubes followed by a final cracking step in one or more adiabatic reactors in sequence or by a quench (tubes/adiabatic or tubes/quench).

Said catalytic tubes are preferably installed in a fired furnace and heated with combustion flue gas.

In further variants, the catalytic tubes operate in parallel with a gas-heater reformer or with one or more adiabatic reactors. For example, the partially cracked effluent of one or more first adiabatic reactor(s) is fed partly to the catalytic tubes and partly to a parallel gas-heated reactor (GHR). Said gas-heated reactor can be heated with the hot effluent of the catalytic tubes. For example, said gas-heated reactor can be a shell-and-tube reactor where cracking is performed in the tube side and said hot effluent traverses the shell side.

In embodiments with a gas-heated reactor, the effluent of said reactor is typically at high temperature. According to various implementations, heat can be removed from said effluent in a steam boiler or in a reboiler of an ammonia distillation column. Alternatively, the stream can be quenched with water and/or steam.

In a further variant of the second embodiment, the cracked stream effluent from the catalytic tubes is quenched before or after a passage in a steam boiler. In a further variant, said quench is performed but no steam boiler is installed. In absence of said boiler, heat for the reboiling of ammonia distillation column can be provided electrically, as in the above-mentioned hybrid options.

As alternative to the steam reboiler an ammonia reboiler can be installed.

### Third Embodiment

A third embodiment includes a plurality of adiabatic cracking steps performed in catalytic beds contained in a single pressure vessel, with inter-bed heating which is preferably electric. Preferably the cracking is performed entirely in this sequence of catalytic beds, that is without passing the process gas through catalytic tubes of a furnace. A variant of this embodiment, however, includes at least one cracking step performed in externally heated catalytic tubes.

The inter-bed heaters may also include at least one heat exchanger arranged to recover heat from a stream of process gas and/or from a stream of flue gas.

### DETAILED DESCRIPTION OF THE FIGURES

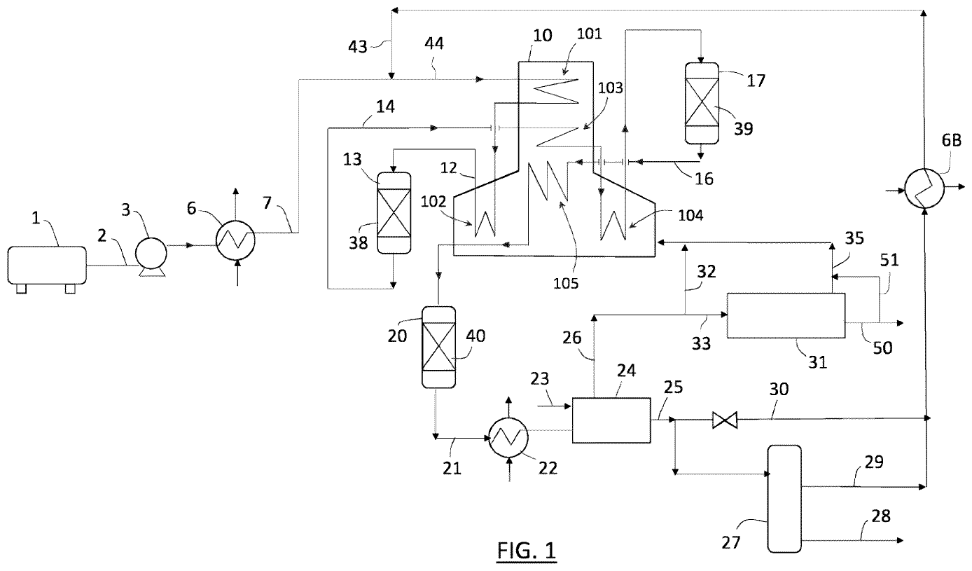

FIGS. 1 to 3 show diagrams of a plant for producing hydrogen according to embodiments of the inventive process.

FIG. 1 illustrate the following main units.
Ammonia storage unit 1
Pump 3
Evaporator 6
Ammonia Recycle Evaporator 6B
Fired furnace 10
Adiabatic cracking reactors 13, 17, 20 with catalytic beds 38, 39, 40
Heat exchanger 22
Scrubber 24
Hydrogen separation unit 31
Distillation column 27
Heating elements 41

FIG. 1 discloses a diagram of a process wherein ammonia 2 is cracked to produce a hydrogen stream 50.

A stream of liquid ammonia 2 is withdrawn from the ammonia storage tank 1 and fed via the pump 3 to the evaporator 6 wherein the liquid ammonia is evaporated into a gaseous ammonia stream 7.

The ammonia preheater/evaporator 6 can be a multistage heat exchanger. Each stage may be a separate apparatus (separate heat exchanger), or multiple stages may be included in a single apparatus.

In some embodiments the evaporator 6 may include a stage arranged to recover heat from the purified hydrogen stream 50 product outlet from the hydrogen separation unit 31, optionally after the separation of a fuel portion 51, and/or the evaporator 6 may include a stage arranged to recover heat from the cracked gas downstream the last ammonia cracking step.

The gaseous ammonia 7 is mixed with a recycle ammonia stream 43 (described below); the so obtained ammonia feed 44 is subjected to heating step in the coils 101, 102 of the fired furnace 10 to generate a pre-heated ammonia feed 12, which is then treated in the first adiabatic cracking reactor 13 to partially crack ammonia into nitrogen and hydrogen.

Output of the first adiabatic reactor 13 is a partially cracked stream 14 comprising nitrogen, hydrogen and uncracked ammonia which is further heated in the furnace 10, traversing the coils 103 and 104, and subjected to a second step of cracking in the second cracking adiabatic reactor 17.

The effluent stream 16 of said second adiabatic reactor 17 is again heated in the furnace 10, traversing the coil 105, and is then subjected to a third step of cracking in the third adiabatic cracking reactor 20. Said third adiabatic reactor 20 is referred to as final or last cracking reactor. Output of said last adiabatic cracking reactor 20 is a cracked steam 21 comprising nitrogen, hydrogen and residual ammonia.

Said cracked stream 21 has a temperature preferably in the range of 400° C. to 500° C. Preferably, no more than 5% in volume of residual ammonia is present in said stream 21.

The cracking of the ammonia is performed catalytically. Each adiabatic reactor includes at least one catalytic bed for this purpose. The adiabatic reactors 13, 17 and 20 include at least one catalytic bed 38, 39 and 40 respectively.

The cracked stream 21 is cooled down in the heat exchanger 22 to a temperature from about 5° C. to about 60° C., preferably 5 to 50° C. Preferably the cooling is performed by direct quenching and/or by indirect heat transfer with a cooling medium. The cooling medium is preferably the fresh liquid ammonia feed and/or water/steam.

In some embodiments, an additional heat exchanger (not shown) after said heat exchanger 22 is arranged to recover heat form the cracked stream for the evaporation of the ammonia feed, thus operating as a stage of the ammonia evaporator 6.

After cooling, the cracked stream is contacted with water 23 in the scrubber 24 for removing residual ammonia. Outputs of the scrubber 24 are an aqueous ammonia solution 25 and a scrubbed gas 26 which includes nitrogen and hydrogen.

The scrubbed gas 26 is separated into a first portion 33 and a second portion 32. Preferably the first portion 33 is a major portion of the effluent 26 and the second portion 32 is a minor portion thereof. The first portion 33 is treated in a hydrogen separation unit 31 to obtain a hydrogen stream 50 and a tail gas 35.

The tail gas 35 comprises nitrogen and low amounts of hydrogen. Said tail gas 35 is recycled to the fired furnace 10 to be used as a fuel, preferably together with a stream of make-up fuel necessary for firing control purposes. Said make-up fuel includes preferably a portion 51 of the hydrogen product stream 50 and/or the second portion 32 of scrubbed gas. Using a portion of the hydrogen 50 as fuel of the furnace 10 is advantageous to reduce carbon emissions.

The aqueous ammonia solution 25 effluent is preferably treated in the distillation unit 27 to separate an ammonia stream 29 from water 28. In some embodiments, all or part of the ammonia solution 25 can bypass the distillation unit 27 via the line 30. The recycle ammonia stream 43 includes the ammonia stream 29 separated in the unit 27 and possibly the bypass portion of line 30. Said recycle stream 43 mixes with the fresh ammonia 7 to form the feed 44 of the adiabatic reactors 13, 17, 20, as described above.

The recycle stream 43 is liquid ammonia which is preferably evaporated before mixing with the fresh ammonia 7. In FIG. 1, the recycle stream 34 is evaporated in an ammonia recycle evaporator 6B. Said ammonia recycle evaporator 6B can be separate from the main feed evaporator 6 or be integrated as one stage of said evaporator 6, preferably a last stage. If the ammonia recycle evaporator 6b is integrated as ammonia recycle evaporation stage in the evaporator 6, the injection point of the stream 43 is positioned upstream said stage.

It can be noted that the effluent of each reactor of the sequence is entirely sent to the next reactor, after heating in one or more coils of the furnace 10.

The number of heating coils in the furnace 10 may vary, for example the sequence of coils 101, 102 and 103, 104 may be replaced by a single coil or more than two coils if appropriate, and properly arranged to optimize the overall thermal heat exchange.

The coils 101-105 in the furnace 10 may be replaced by bundle of tubes or other suitable heat exchange elements, exposed to hot fumes in the furnace and internally traversed by the stream to be heated.

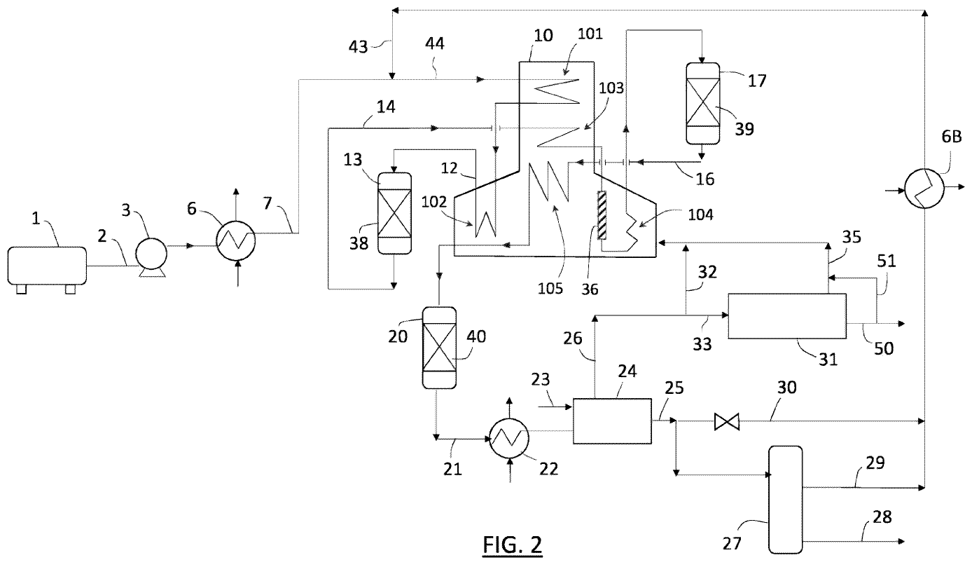

FIG. 2 shows an embodiment which is a variant of FIG. 1 wherein an additional cracking step is performed in a bundle of catalytic tubes 36. The tubes 36 are filled with ammonia cracking catalyst and are externally heated by the combustion process in the furnace 10. The partially cracked stream 14 after heating in the coil 103 is subjected to cracking in the catalytic tubes 36 and then heated in the coil 104 and treated in the downstream reactors 17 and 20 to generate the cracked gas 21. Other features of the process are same as in FIG. 1.

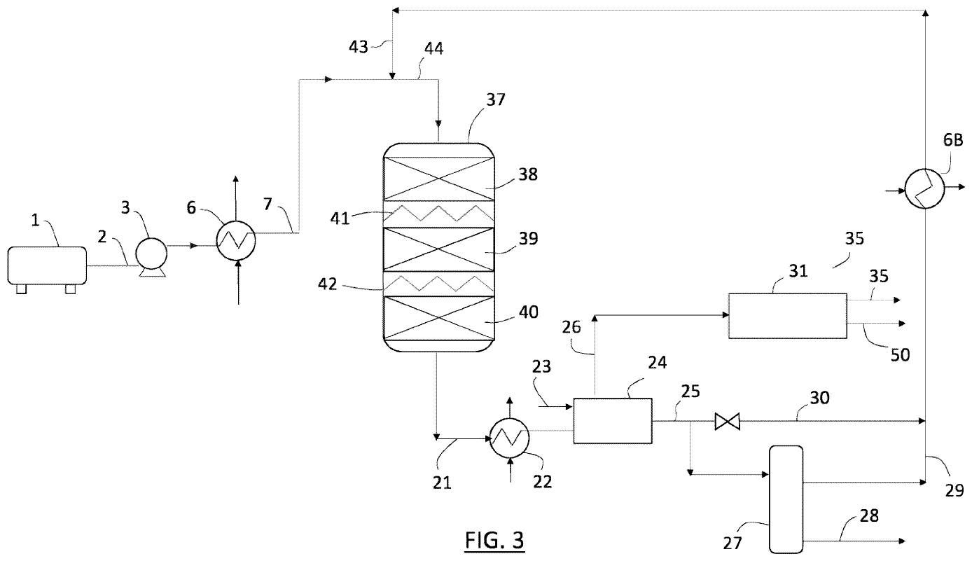

FIG. 3 shows an embodiment wherein the cracking process is carried out in a single adiabatic cracking reactor 37 which accommodates the catalytic beds 38, 39, and 40. Accordingly, said catalytic beds are provided in a single reactor instead of separate pressure vessels 13, 17, 20 of FIGS. 1-2.

The adiabatic reactor 37 also includes heating elements 41, 42 which are interposed between consecutive catalytic beds. The heating elements 41, 42 are preferably electrical heaters which are configured to heat an effluent of a catalytic bed prior to a subsequent catalytic bed. The effluent of the bed 38 is heated by the heater 41 before entering the bed 39 and the effluent of said bed 39 is heated by the heater 42 before entering the bed 40.

In some embodiments the heating elements 41, 42 can be heat exchangers and/or coils arranged to recover heat from process streams and/or flue gas. The flue gas may be gas from the furnace 10 and/or exhaust stream of a gas turbine.

1-23. (canceled)

24. A process for production of hydrogen from ammonia, the process comprising:
ammonia cracking including a gaseous ammonia feed is catalytically decomposed into hydrogen and nitrogen, wherein the ammonia cracking is performed in a sequence of ammonia cracking steps wherein a finally cracked stream is a stream obtained after a last ammonia cracking step of said sequence, wherein:
said last ammonia cracking step is performed adiabatically without providing heat to the process stream under cracking, and/or
said finally cracked stream is quenched by direct mixing with water and/or steam after said last ammonia cracking step;
wherein the sequence of ammonia cracking steps includes:
a plurality of cracking steps performed in a sequence of adiabatic reactors connected in series, and optionally one or more cracking steps in catalytic tubes, so that the effluent of each reactor is further processed in a next reactor or in a bundle of catalytic tubes, until the last reactor of the sequence produces the finally cracked stream, and intermediate heating steps wherein the effluent of a reactor is heated before entering the next reactor of the sequence to provide heat for the endothermic cracking of ammonia, wherein no further cracking of ammonia is performed during the heating steps; or
at least one cracking step which is performed in a bundle of externally-heated catalytic tubes, said process including a parallel cracking step which is performed in parallel to the cracking step in the externally-heated catalytic tubes, said parallel cracking step being performed in a gas-heated reactor or adiabatically in an adiabatic reactor.

25. The process according to claim 24, wherein said finally cracked stream, after the last step of cracking or after quenching if provided, has a temperature not greater than 700° C. or not greater than 650° C. or not greater than 550° C. or not greater than 450° C.

26. The process according to claim 24, wherein the temperature of the feed of each cracking step is 300° C. to 650° C.

27. The process according to claim 24, wherein said finally cracked stream is cooled by indirect heat exchange with one or more cooling fluids in one or more heat exchangers, said cooling fluids include a fresh liquid ammonia feed, which is heated and evaporated to produce said gaseous ammonia feed, and/or water which is evaporated to produce steam.

28. The process according to claim 24, wherein said heating steps are performed in a fuel-fired furnace.

29. The process according to claim 24, wherein said at least one cracking step performed in a bundle of externally-heated catalytic tubes is preceded and/or followed by one or more cracking steps performed adiabatically in one or more catalytic reactors.

30. The process according to claim 24, wherein the parallel cracking step is performed in a gas-heated reactor and said reactor is heated with a cracked stream effluent from the catalytic tubes.

31. The process according to claim 24, wherein the parallel cracking step is performed in a gas-heated reactor and the effluent of said gas-heated reactor is cooled in a boiler or by quenching.

32. The process according to claim 31, wherein the effluent of the gas-heated reactor is cooled in a boiler which is arranged to provide heat for re-boiling a distillation process of an aqua-ammonia solution and for a pre-heating of fresh ammonia, or said boiler is a re-boiler of an ammonia distillation column.

33. The process according to claim 24, wherein the fresh ammonia feed is first cracked adiabatically in one adiabatic reactor or in a sequence of adiabatic reactors; a portion of the partially cracked effluent of the one adiabatic reactor, or of the last reactor of the sequence, is further cracked in the catalytic tubes; the remainder portion of said partially cracked effluent is cracked in a parallel reactor which is either an adiabatic reactor or a gas-heated reactor, the effluent of the tubes and the effluent of the parallel reactor are rejoined to form a finally cracked stream.

34. The process according to claim 24, wherein the effluent of the catalytic tubes is quenched before or after a boiler.

35. The process according to claim 24, wherein the sequence of ammonia cracking steps includes a plurality of cracking steps performed adiabatically in a sequence of catalytic beds, said catalytic beds being hosted in a single reactor with a single pressure vessel, said reactor including one or more inter-bed heaters arranged to provide heat for the endothermic cracking of ammonia.

36. The process according to claim 35, wherein the inter-bed heaters include any of: electric heaters, heat exchanger arranged to recover heat from process gas, heat exchangers arranged to recover heat from flue gas.

37. The process according to claim 36, further including at least one cracking step performed in externally heated catalytic tubes.

38. The process according to claim 24, wherein the cracking process is hybridized by providing a heat input which is produced electrically, preferably by using electric power from a renewable source, wherein said heat input includes one or more of:
heat for reboiling an aqua-ammonia solution;
heat for pre-heating or evaporating a liquid ammonia feed;
heat for pre-heating combustion air of a fuel-fired furnace; or
heat for cracking ammonia.

39. The process according to claim 24, further comprising addition of a makeup of hydrogen which is taken from a hydrogen storage or from a buffering system and is added to a fuel gas system of the process, to stabilize and control the ammonia cracking process, said addition being made preferably during a start-up procedure to sustain the start-up process.

40. The process according to claim 24, wherein at least a portion of fuel feed of a fired furnace is provided by one or more of the following:
a tail gas withdrawn from a hydrogen purification process, such as a pressure swing absorption process;
a portion of the hydrogen product;
a portion of gas obtained by treating said finally cracked stream in a scrubber; or
a portion of the fresh ammonia feed, optionally after a pre-cracking step.

41. The process according to claim 24, wherein a portion of the fuel of the process is sent to a gas turbine and exhaust gas of said turbine are used as a heat source in the ammonia cracking process, and/or exhaust gas of said turbine is used to generate steam for a steam turbine.

42. The process according to claim 24, where natural gas or another external fuel source is used to supplement the fuel gas of the process.

43. The process according to claim 24, wherein—in said sequence of ammonia cracking steps—the effluent of each cracking step is entirely sent to the next cracking step.

44. The process according to claim 24, wherein a feed of liquid ammonia is evaporated to produce said gaseous ammonia feed, wherein at least a portion of the heat for the evaporation of said liquid ammonia is recovered from a stream of hydrogen product and/or from said finally cracked stream.
